(19) United States
(12) Patent Application Publication
(10) Pub. No.: US 2006/0176823 A1
(43) Pub. Date: Aug. 10, 2006

(54) Smart actuator topology

(76) Inventor: Leandro G. Barajas, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(21) Appl. No.: 11/055,370

(22) Filed: Feb. 10, 2005

(51) Int. Cl. H04L 12/56; H04J 3/14

(52) U.S. Cl. 370/241; 370/216; 370/254

(57) ABSTRACT

A smart actuator apparatus provides controlled connection between a source and a load and includes a redundant switching network and sensors adapted for diagnosing smart actuator conditions and conditions external to the smart actuator. Switching network states are preferably establishable in accordance with multiple alternative network configurations. Network diagnostics enable recovery from establishment faults and reconfiguration of the network to provide the desired state. Source and load condition diagnosis is also enabled by the sensors.

### TECHNICAL FIELD

The present invention is related to actuation systems. More particularly, the present invention relates to so-called smart actuators.

### BACKGROUND OF THE INVENTION

Many actuation systems employ switching redundancy to improve system reliability and availability. Redundancy is particularly important in critical control applications to ensure that actuation commands are carried out. Redundancy may be employed for one or both actuation states (i.e. ON and OFF) in a binary switching application.

Typical redundancy relies upon a control architecture that is highly centralized and individual actuation hardware that is spatially distributed. Control functions of redundant switching networks are carried out at a high level. This is true in process control applications such as manufacturing or in product applications such as automotive system controls for example. Controllers, whether industrial programmable logic controller (PLC) based or microprocessor based, are conventionally adapted with a one-to-one mapping of redundant switches or actuators to controller outputs. Of course, each such switch or actuator therefore requires at least one of a limited number of outputs of the microprocessor or PLC. Each actuation function thereby consumes a significant amount of hardware I/O functionality. Moreover, such redundancy consumes significant processor or PLC system throughput resources to manage a single actuation function. Hardware and software resource utilization is even further strained when redundancy is employed for each actuation state (e.g. ON and OFF). Such high-count I/O applications may be prohibitively expensive and impractical.

Diagnosis or validation of such actuation systems requires even more I/O resources. And, in redundant actuation systems that are not passively redundant, at least one additional controller I/O point may be required for each switch or actuator. Even so, such diagnosis remains incomplete in as much as the state of the load that is the target of actuation remains unknown and unvalidated. This may not be acceptable in certain critical applications.

### SUMMARY OF THE INVENTION

The present invention is a smart actuator that requires minimal I/O resources from higher level controls. Actuator control and diagnosis is accomplished as part of the smart actuator functionality and, advantageously, additional external diagnosis is also made available.

In accordance with the present invention, a smart actuator for controllably coupling a source to a load includes a network having a plurality of redundantly establishable network states. Means for establishing the network into one of the plurality of redundantly establishable network states corresponding to a desired network state command are provided. The load is validated by a load diagnosis means, and feedback means provide smart actuator diagnostic information. The means for establishing the network includes network state diagnosis means for confirming the establishment of the one of the plurality of redundantly establishable network states corresponding to the desired network state command.

In a more particular form, a smart actuator for controllably coupling a source to a load includes a binary switching network having first and second network states wherein at least one of such network states is establishable via any of a plurality of redundant network configurations. The smart actuator also includes network state establishment means responsive to a desired network state command for establishing the binary switching network into a desired one of the first and second network states. Means for diagnosing load conditions and for providing smart actuator diagnostic information corresponding to at least one of the network state conditions and the load conditions are also part of the smart actuator. In one more particular form, the smart actuator also includes means for diagnosing network state conditions. In yet a more particular form wherein a plurality of redundant network configurations are available to establish at least one of the network states, the network state establishment means includes means for configuring the binary switching network into an alternative one of the plurality of redundant network configurations when the means for diagnosing network state conditions diagnoses an abnormal network state condition relative to a current one of the plurality of redundant network configurations.

The present invention is also found in a method for controllably coupling a load to a source and includes providing a network between the load and the source and establishing the network into one of a plurality of network configurations to effect a desired network state. When it is determined that one of the plurality of network configurations fails to effect the desired state, the network is established into an alternate one of the plurality of network configurations to effect the desired network state. Network faults are diagnosed when any one of the plurality of network configurations fails to effect the desired network state. Diagnostic information corresponding to the network based on the network fault is provided. More particularly, load fault diagnosis is also performed based upon non-conformance of a load parameter to an expected range for the load parameter when the desired network state is effected.

### BRIEF DESCRIPTION OF THE DRAWINGS

The drawings, which are understood to be exemplary of a preferred embodiment of the present invention and not limiting thereof, are now referred to wherein:

FIG. 1 is a schematic block diagram of a redundant smart actuator system in accordance with the present invention;

FIG. 2 is a schematic block diagram of a preferred embodiment of a dual redundant binary switching smart actuator system in accordance with the present invention; and

FIG. 3 is a functional block diagram illustrating various operations carried out by the smart actuator in accordance with the present invention.

### DESCRIPTION OF THE PREFERRED EMBODIMENT

The present invention will now be described with reference to the figures which illustrate general and preferred embodiments of a smart actuator 301 in application with a microprocessor or PLC based control 210. Smart actuator 301 is shown in operative communication with control 210 via lines 211 and 213 in the figure. Lines 211 and 213 comprise any of a variety of appropriate communication means including hardwired or wireless communications. In hardwired communications, data transmission comprises serial or parallel data in accordance with the particular application. For example, high speed applications may benefit from parallel bus communication whereas in applications wherein high speed communication is not so critical, serial data transmission may be sufficient. Control 210 may be an independent control or part of a more complex network of additional controllers (not separately illustrated) communicating via any of a variety of bus/networks 215, including closed and open networks. Though not separately illustrated, smart actuator 301 may also be adapted for communication directly over network 215 or any intermediate network or bussed communication means.

With particular reference to smart actuator 301, a redundant network 302 is coupled between a source 401 and a load 403 for providing a controlled connection therebetween. A variety of application environments are envisioned for the present invention including, but not limited to, electrical, mechanical (including micro-mechanical), magnetic, pneumatic, hydraulic and communication. Fluid transport systems, for example in hydraulic control systems, signal switching systems, for example in telecommunication or telematics systems, and actuation systems, for example in industrial and automotive electrical systems are more specific and diverse examples of applications of the present invention. In the example of fluid transport systems, redundant network 302 may include means for selectively routing a source of pressurized fluid to hydraulic circuit elements. In the example of signal switching systems, redundant network 302 may include signal processing software routines means for selectively routing transactions between client and server applications. A more detailed exemplary automotive electrical system application is set forth below in further exemplifying the present invention.

An exemplary source 401 includes a direct-current (DC) voltage source and an exemplary load includes an electrical resistance. More particularly, an automotive application may define the source 401 as a vehicular electrical source such as the regulated alternator output or battery voltage and the load as one or more service brake application indicator lamps. Other types of sources may include, for example, alternating-current (AC) voltage sources, AC or DC current sources and other types of loads may include, for example, various active loads. An exemplary redundant network 302 includes a binary switching network characterized by two network states corresponding to simple connection and disconnection of the source 401 to the load 403 (i.e. ON and OFF, respectively). Redundant network 302 may be characterized by additional functionality including voltage or current regulation, circuit protection, and latching, for example. Redundant network may be characterized by electromechanical switches (e.g. relays), solid-state switches including optically isolated switches, micro-mechanical switches, other analog and digital circuit components and combinations thereof to effect the desired controlled circuit connection functionality. High-speed/frequency applications may benefit from solid-state switching whereas high-current applications may benefit from electromechanical switching. Additionally, the present invention is not limited in application to power sources and loads, and binary switching therebetween; rather, the source 401 and load 403 represent any sub-circuits desirably controllably connected via redundant network 302 performing a predetermined function.

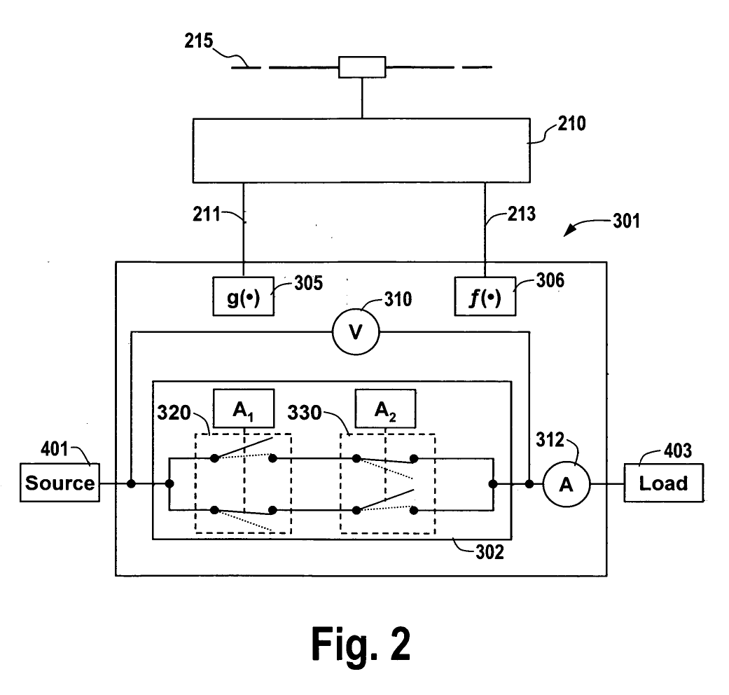

Redundant network 302 may be passively or actively redundant. In a passively redundant network, multiple circuits simultaneously perform the function of the network. For example, a simple redundant switching network may include two or more switches that are all actuated to a closed or open position simultaneously. Failure of closure of one switch is passively accounted for by the other of the redundant switch(es). Networks can be readily designed for redundant opening protection, for example through series arrangements of switches wherein failure of one such switch to open is passively accounted for by the other of the series connected redundant switch(es). Other passive redundant networks are well known to those skilled in the art and are not further detailed herein. In an actively redundant network, multiple circuits individually—and generally mutually exclusively—perform the function of the network. Generally, in an actively redundant network, alternative configurations can be established to effect the desired network state or function. Failure of one of the multiple configurations to effect the desired network function can be accounted for by any of the other of such multiple configurations. A simple exemplary actively redundant network is described herein below with respect to the dual redundant binary switching network of FIG. 2.

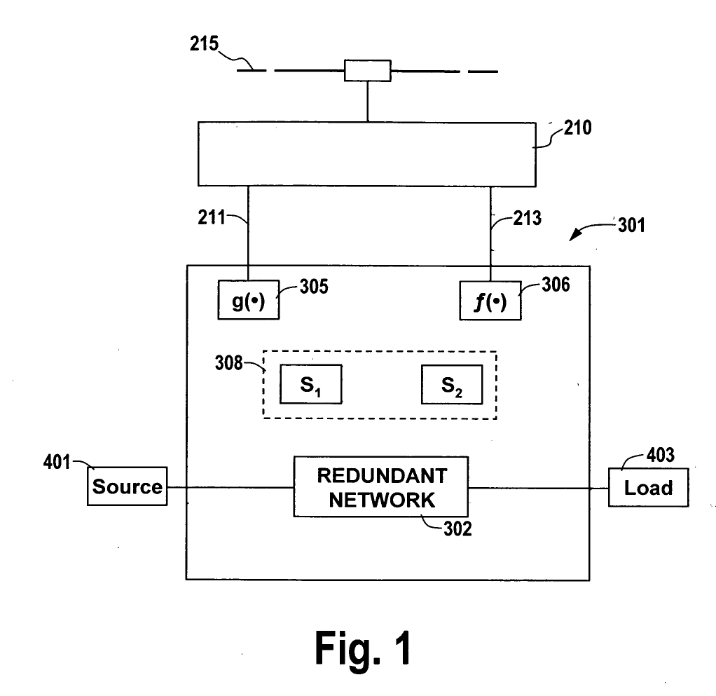

With particular reference to the general embodiment of the invention illustrated in FIG. 1, smart actuator 301 further includes diagnostic circuitry and function 308 including one or more sensors (S₁, S₂). In the present example of a binary switching network controllably coupling a voltage source 401 to load 403, diagnosis circuitry and function 308 of smart actuator 301 determines network state conditions including at least the overall network state (i.e. ON or OFF) of redundant network 302. Preferably, diagnosis circuitry and function 308 of smart actuator 301 also determines the condition of load 403 and source 401. For an actively redundant network, diagnosis of the network state may provide diagnostic information that is used internally by the smart actuator 301 to recover from a network fault by establishing alternative network configurations to effect the desired network state as will be described further herein below. Additionally, diagnostic information regarding the network state and establishment faults may be usefully communicated or provided by the smart actuator, for example to control 210 or network 215 for many purposes, including maintenance, service scheduling, control re-routing, etc.

Control circuitry 305 within the smart actuator 301 receives commands from control 210 via line 211 indicative of the desired network state. Circuitry 305 may be implemented in completely analog fashion or through discrete logic networks in certain applications. However, circuitry 305 is preferably microcontroller based with conventional control and logic circuitry as required by the particular application including a CPU, read-only and read-write memory devices in which are stored a plurality of routines for carrying out operations in accordance with the present invention, including routines for communicating with control 210 and establishing configurations of redundant network 302 to effect the desired network state as represented in the commands provided by control 210. Establishing configurations of redundant network 302, as described above, may include the diagnosis of the network state and fault recovery to establish alternative network configurations to effect the desired network state. As such, sensor monitoring and signal processing as required for diagnosis circuitry and function 308 are also preferably performed within smart actuator 301 by microcontroller based control circuitry 305. However, diagnosis circuitry and function 308 may be implemented in completely analog fashion or through discrete logic networks in certain applications. Such sensor monitoring, network and load diagnosis and recovery relieves such processing functions from the controller 210 and advantageously eliminates the attendant throughput constraints and delays. Feedback circuitry 306 within the smart sensor 301 provides smart actuator diagnostic information to control 210 via line 213. Information communicated includes network 302 condition information and source 401 and load 403 condition information. Circuitry 306 may be implemented in completely analog fashion or through discrete logic networks in certain applications. However, circuitry 306 is preferably microcontroller based with conventional control and logic circuitry as required by the particular application and preferably is implemented utilizing shared resources with microcontroller based control circuitry 305. Being processor based, such control, diagnosis and feedback circuitry, 305, 308 and 306, can be custom programmed to satisfy specific system requirements and later reprogrammed or re-calibrated as needed.

With reference now to FIG. 2, a more particularly detailed embodiment of a smart actuator 301 includes an alternately configurable dual-redundant binary switching network 302, a voltage sensor 310 and current sensor 312. Switching network 302 comprises a first pair of commonly actuated switch elements 320 having complementary switch states wherein a closed state of either switch element corresponds to an open state of the other switch element. The switch elements 320 have first states illustrated in solid lines and second states illustrated in dotted lines. Switching network 302 also comprises a second pair of commonly actuated switch elements 330 having complementary switch states wherein a closed state of either switch element corresponds to an open state of the other switch element. The switch elements 330 have first states illustrated in solid lines and second states illustrated in dotted lines. The switch elements 320 and 330 have respective actuation means (A₁ and A₂) for establishing the switch element states. Actuation means A₁ and A₂ may be control solenoids in the case of electromechanical switches or appropriate gate drive circuitry in the case of certain solid-state switches, for example. Actuation means A₁ and A₂ are controlled by control circuitry 305 in accordance with the desired network state commands received by smart actuator 301 and the network state diagnostic and recovery functionality thereof to configure the switching network 302 to establish the desired network state (i.e. ON or OFF).

From FIG. 2 and the preceding description, it is appreciated that a plurality of network configurations comprising the various switch element combinations is possible. In the exemplary embodiment illustrated in FIG. 2, an ON state of the network 302 is assumed to correspond to a closed circuit path (i.e. short) through switching network 302 and an OFF state of the network 302 is assumed to correspond to an open circuit path (i.e. open) through switching network 302. The OFF state of the network 302 is therefore seen to be configurable when the first switch elements 320 are in their respective first states and the second switch elements 330 are in their respective first states. Alternatively, the OFF state of the network 302 is configurable when the first switch elements 320 are in their respective second states and the second switch elements 330 are in their respective second states. Similarly, the ON state is seen to be configurable when the first switch elements 320 are in their respective second states and the second switch elements 330 are in their respective first states or when the first switch elements 320 are in their respective first states and the second switch elements 330 are in their respective second states.

Microprocessor based circuitry 305 is also responsible for acquiring sensor data—in the present example from voltage sensor 310 and current sensor 312. Voltage sensor 310, connected across the switching network 302 is effective to measure the voltage differential thereacross and is particularly useful in the diagnosis of the switching network condition and fault recovery. For example, desired network state command ON from control 210 may be translated into control signals for each of the actuators A₁ and A₂ to establish the network 302 into one of the available alternative configurations corresponding to the switching network ON state. A normal switching network condition corresponding to the desired network state command ON would be indicated by a voltage measurement of substantially zero volts. An abnormal switching network condition corresponding to the desired network state command ON (e.g. open switch element or high circuit impedance) on the other hand would be indicated by a voltage measurement of some level other than substantially zero volts. An abnormal switching network condition corresponding to the desired network state command ON is therefore diagnosed by circuitry 305 which responds by attempting an alternate available configuration to establish the redundant network 302 into the ON state. Feedback circuitry 306 would appropriately communicate diagnostic information respecting the switching network 302 to control 210. Voltage sensor 310 is also useful in the diagnosis of the source 401 condition. Assuming an established OFF state for the redundant network 302, a normal source condition would be indicated by a voltage measurement within a range of acceptable values. An abnormal source condition (e.g. open, short circuit, unregulated) on the other hand would be indicated by a voltage measurement of some level other than within the range of acceptable values. An abnormal source condition, therefore, may be indicated by too high or too low a value of voltage indicating a short, open, regulation fault or other anomaly at the source side of the smart actuator 301. An abnormal source condition is therefore diagnosed by circuitry 305. Feedback circuitry 306 would appropriately communicate diagnostic information respecting the source 401 to control 210.

Current sensor 312 connected to measure the current flowing into the load is particularly useful in the diagnosis of the load condition. From the example above assuming an established ON state for the redundant network 302, a normal load condition would be indicated by a current measurement within a range of acceptable values. An abnormal load condition (e.g. open or short circuit) assuming an established ON state for the redundant network 302 on the other hand would be indicated by a current measurement of some level other than within the range of acceptable values. An abnormal load condition, therefore, may be indicated by too high or too low a value of current indicating a short, open or other anomaly at the load side of the smart actuator 301. An abnormal load condition is therefore diagnosed by circuitry 305. Feedback circuitry 306 would appropriately communicate diagnostic information respecting the load 403 to control 210. The voltage sensor 310 and current sensor 312 together provide a comprehensive arrangement for diagnostic and recovery of the actuated system, including the health and validation of the smart actuator's redundant switching network 302, the source 401 and the load 403.

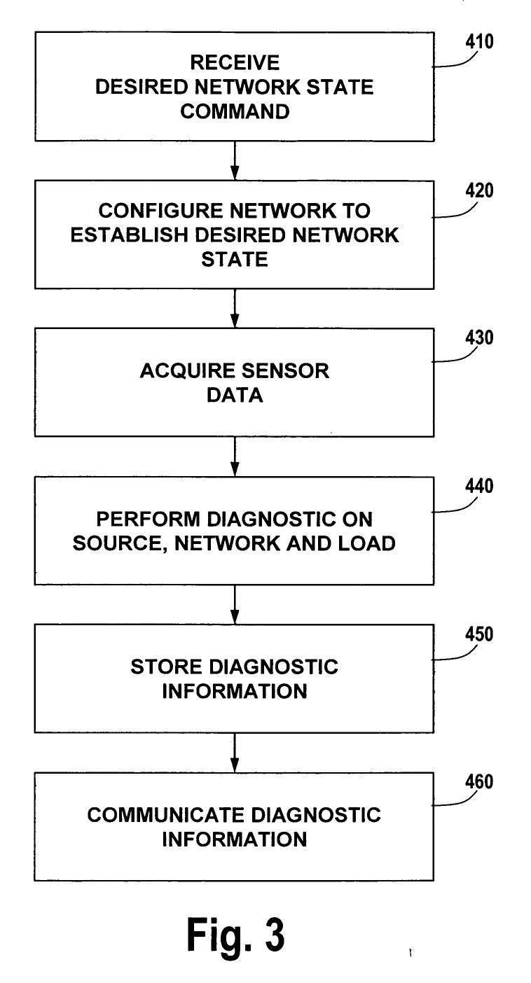

FIG. 3 illustrates certain exemplary operations carried out by the microcontroller based control circuitry 305 and feedback circuitry 306 in accordance with the present invention and instruction sets stored, for example, in non-volatile memory devices. Though illustrated generally as a plurality of serial sub-operations 410 through 460, one skilled in the art will recognize that the operations are not necessarily carried out in such ordered fashion. Such sub-operations may be performed independently and on a regular basis such as through a conventional timer interrupt loop or through other irregular interrupts such as event based interrupts or polling.

Beginning first with block 410, a desired network state command is received by smart actuator 301. Network state commands are, as described above, acted upon by the smart actuator to effect the desired network state. Control 210 is generally responsible for controlling the communication timing of network commands in accordance with an overall system control being managed thereby.

Block 420 represents steps executed to configure the network to establish the network state in accordance with the desired network state command. If the redundant network is not passively redundant, then diagnostic information related to the network condition is used at this point in establishing alternate configurations of the network to establish the desired network state. If diagnostic information related to the present configuration indicates a failure of the network to establish the desired network state in accordance with the desired network state command, then an alternate network configuration is established to effect the desired network state. The number of alternate network configurations is limited only by the degree of redundancy designed into the redundant network. For higher levels of redundancy, e.g. triple redundancy, an iterative process may be followed in establishing the network configuration in accordance with the desired network state command. Historical diagnostic data (i.e. stored diagnostic information) may also be utilized at this point where previous network configurations that have failed to establish the network into the desired network state are no longer considered to be viable alternative configurations.

Next, block 430 represents sensor element data acquisition including steps necessary to read the individual voltage and current sensors. Such steps may be performed on a regular basis such as through a conventional timer interrupt loop or through other irregular interrupts such as event based interrupts (i.e. subsequent to network configuration changes). The frequency of data acquisition will vary in accordance with such factors as the parameter being sensed and the measurement principle of the sensing element. Block 430 also represents the conditioning of the sensor element data so acquired. For example, signal conditioning comprising conventional “debouncing”, filtering, averaging, error and offset compensations, linearization, etc. are performed on the acquired data. Analog to digital conversion is also performed on the data as part of the signal conditioning.

Sensor data can then be utilized in diagnosing network, source and load conditions as illustrated at block 440. As previously described, examples of such diagnostic information includes not only information related to the condition of the smart actuator 301, but may also include information related to the condition of parts of the system external to the smart actuator (i.e. source 401 and load 403).

Block 450 next represents storage of data which may include individual sensor element data, diagnostic and prognostic data. Finally, block 460 represents communication management and data transfer between the smart actuator 301 and control 210 or other busses or networks 215. Communication of diagnostic information respecting the health of the smart actuator may be effected upon polling from control 210 or at the initiation of feedback circuit 306.

The invention has been described with respect to certain preferred embodiments that are intended to be taken by way of illustration of the invention and not by way of limitation.

1. Smart actuator for controllably coupling a source to a load, comprising:
a network having a plurality of redundantly establishable network states;
network state establishment means for establishing said network into one of said plurality of redundantly establishable network states corresponding to a desired network state command;
load diagnosis means for validating the load; and
feedback means for providing smart actuator diagnostic information.

2. The smart actuator as claimed in claim 1 wherein said network state establishment means comprises network state diagnosis means for confirming the establishment of the one of said plurality of redundantly establishable network states corresponding to the desired network state command.

3. The smart actuator as claimed in claim 1 wherein said load diagnosis means comprises network state diagnosis means for confirming the establishment of the one of said plurality of redundantly establishable network states corresponding to the desired network state command.

4. The smart actuator as claimed in claim 3 wherein said load diagnosis means comprises means for confirming a load parameter conforms to an expected range for said load parameter that corresponds to the one of said plurality of redundantly establishable network states corresponding to the desired network state command.

5. The smart actuator as claimed in claim 2 wherein said network state establishment means comprises means for establishing alternative network configurations until said network state diagnosis means confirms the establishment of the one of said plurality of redundantly establishable network states corresponding to the desired network state command.

6. The smart actuator as claimed in claim 1 wherein said smart actuator diagnostic information comprises load diagnosis information.

7. The smart actuator as claimed in claim 2 wherein said smart actuator diagnostic information comprises network state diagnosis information.

8. The smart actuator as claimed in claim 3 wherein said smart actuator diagnostic information comprises network state diagnosis information and load diagnosis information.

9. The smart actuator as claimed in claim 4 wherein said smart actuator diagnostic information comprises network state diagnosis information and load diagnosis information.

10. The smart actuator as claimed in claim 5 wherein said smart actuator diagnostic information comprises network state diagnosis information, network configuration information and load diagnosis information.

11. The smart actuator as claimed in claim 1 wherein said network comprises a binary switching network and said plurality of redundantly establishable network states comprises opened and closed states.

12. The smart actuator as claimed in claim 5 wherein said network comprises a binary switching network and said plurality of redundantly establishable network states comprises opened and closed states.

13. Smart actuator for controllably coupling a source to a load, comprising:
a binary switching network having first and second network states, at least one of said first and second network states being establishable via any of a plurality of redundant network configurations;
network state establishment means responsive to a desired network state command for establishing said binary switching network into a desired one of said first and second network states;
means for diagnosing load conditions; and
feedback means for providing smart actuator diagnostic information corresponding to at least one of said network state conditions and said load conditions.

14. The smart actuator for controllably coupling a source to a load as claimed in claim 13 further comprising means for diagnosing network state conditions.

15. The smart actuator for controllably coupling a source to a load as claimed in claim 14 wherein the desired network state command corresponds to the at least one of said first and second networks states, and said network state establishment means comprises means for configuring said binary switching network into an alternative one of the plurality of redundant network configurations when the means for diagnosing network state conditions diagnoses an abnormal network state condition relative to a current one of the plurality of redundant network configurations.

16. The smart actuator for controllably coupling a source to a load as claimed in claim 13 wherein the means for diagnosing load conditions comprises means for confirming a load parameter conforms to an expected range for said load parameter that corresponds to the established one of said first and second network states.

17. The smart actuator for controllably coupling a source to a load as claimed in claim 14 wherein said means for diagnosing network state conditions comprises a voltage sensor.

18. A smart actuator for controllably coupling a source to a load as claimed in claim 13 wherein said means for diagnosing load conditions comprises a current sensor.

19. The smart actuator for controllably coupling a source to a load as claimed in claim 13 wherein said binary switching network comprises mechanical switches.

20. The smart actuator for controllably coupling a source to a load as claimed in claim 13 wherein said binary switching network comprises solid-state switches.

21. Method for controllably coupling a load to a source, comprising;
providing a network between the load and the source;
establishing the network into one of a plurality of network configurations to effect a desired network state;
determining when the one of the plurality of network configurations fails to effect the desired state and establishing the network into an alternate one of the plurality of network configurations to effect the desired network state;
diagnosing a network fault when any one of the plurality of network configurations fails to effect the desired network state; and
providing diagnostic information corresponding to said network based on said network fault.

22. The method for controllably coupling a load to a source as claimed in claim 21 further comprising diagnosing a load fault based upon non-conformance of a load parameter to an expected range for said load parameter when the desired network state is effected.

23. The method for controllably coupling a load to a source as claimed in claim 21 wherein said network comprises a binary switching network.
